(19) United States
(12) Patent Application Publication
(10) Pub. No.: US 2006/0068961 A1
(43) Pub. Date: Mar. 30, 2006

(54) Lubricating apparatus in a planetary gearset

(76) Inventor: Raymond J. Haka, Brighton, MI (US)

Correspondence Address: LESLIE C. HODGES;General Motors Corporation, Legal Staff, Mail Code 482-C23-B21, P.O. Box 300, Detroit, MI, 48265-3000, US

(21) Appl. No.: 10/951,488

(22) Filed: Sep. 28, 2004

(51) Int. Cl. F16H 57/04

(52) U.S. Cl. 475/159

(57) ABSTRACT

A planetary gear arrangement has a lubrication system in which lubrication fluid is supplied to an inner surface of a sun gear member from where it is centrifugally distributed to the planet carrier assembly member. The distribution system in the planet carrier assembly member includes radial formed passages in the planet carrier side plate and in support pins and longitudinal passages in the support pins, which distribute fluid through radial passages in the support pins. The radial passages in the support pins distribute fluid through an inner surface of pinion gears that are rotatably mounted on the support pins.

### TECHNICAL FIELD

This invention relates to lubrication apparatus and, more particularly, to lubrication apparatus for planet carrier assemblies in a planetary transmission.

### BACKGROUND OF THE INVENTION

Planetary gearsets, which are employed in planetary transmissions for providing a plurality of speed ratios between an input and an output, require lubrication for both the gear elements and for the bearing support structures. The bearing structures or supporting structures for the sun gear are quite simply accommodated by providing passages within the shafting to direct fluid to the sun gear inner surface. However, lubrication for the support bearings of the planet carrier assembly, which includes a plurality of rotatably mounted pinions, is a little more difficult.

In instances where the planet carrier member of the planet carrier assembly is continuously rotating, the lubrication fluid can be presented to the inner diameter of the carrier and centrifugal force will direct the fluid outward to the mounting pins to the inner surface of the planet pinions. However, when the planet carrier is stationary but the pinions are rotating, it is much more difficult to direct fluid flow into the inner surface of the pinion gears. The lubrication process in this instance would require a substantially sealed service at the edge of the planet carrier to which lubrication fluid can be distributed. In instances where the carrier is stationary and the sun or ring are also stationary, there is no relative motion of the pinions to the carrier, and there is no need for lubrication to flow in and out of the pinion bearings.

The present invention seeks to provide lubrication to the planet pinions of a planetary assembly even when the carrier is stationary.

### SUMMARY OF THE INVENTION

It is an object of the present invention to provide an improved lubrication system for a planetary gearset.

In one aspect of the present invention, the planetary gearset includes a sun gear member, a planet carrier assembly member, and ring gear member in which either the planet carrier assembly or the sun gear member is rotating.

In another aspect of the present invention, the sun gear member of the planetary gearset provides a centrifugal feed mechanism for the planet carrier.

In yet another aspect of the present invention, a stationary planet carrier receives lubrication fluid distributed by a centrifugal mechanism associated with the sun gear member.

### DESCRIPTION OF THE DRAWINGS

FIG. 1 is a partial view of a planetary transmission having planetary gearsets incorporating the present invention.

FIG. 2 is an alternative embodiment of the present invention.

### DESCRIPTION OF THE EXEMPLARY EMBODIMENTS

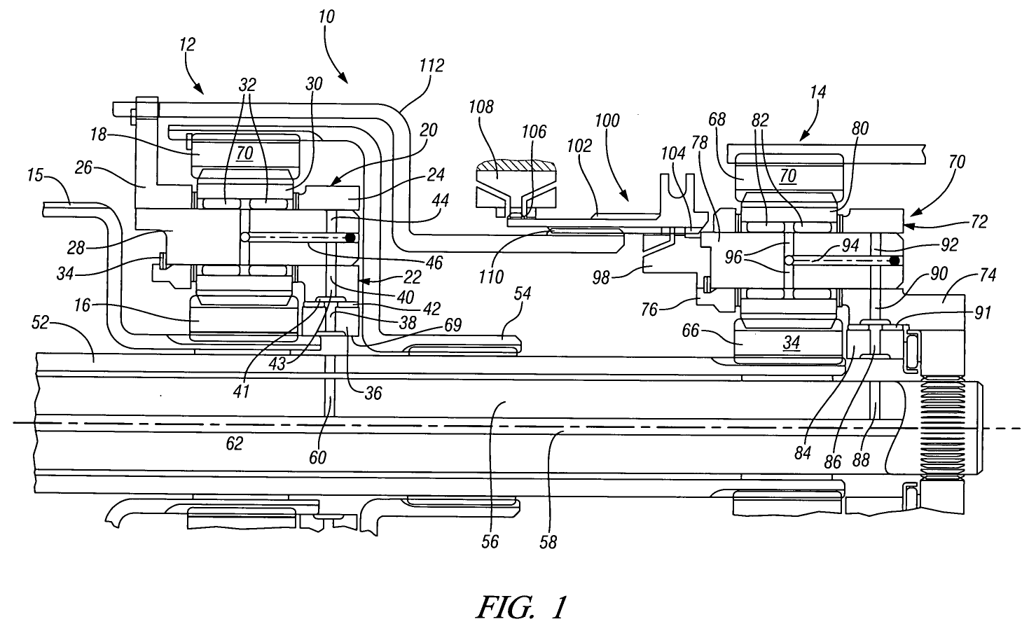

A planetary arrangement 10, as shown in FIG. 1, has a pair of planetary gearsets 12 and 14. The planetary gearset 12 includes a sun gear member 16, a ring gear member 18, and a planet carrier assembly member 20. The planet carrier assembly member 20 includes a planet carrier member, generally designated 22, having a pair of side plates 24 and 26, and a plurality of mounting pins 28. The planet carrier assembly member 20 also includes a plurality of pinion gears 30 rotatably mounted on bearings 32 on the pins 28. The pins 28 are generally fixed in position relative to the side plates 24 and 26 and are limited in axial movement by a locking ring 34.

The sun gear member 16 has an extension 36, which incorporates a plurality of radial passages 38 alignable with radial passages 40 and an oil gallery 41 formed in the side plate 24. The oil gallery 41 insures that the passages 40 have a substantially continuous oil reservoir. The extension 36 has a bearing member 42 disposed between the outer surface thereof and the side plate 24. The bearing 42 has a plurality of radial passages 43, which permits fluid flow. The radial passages 40, 43 are aligned with radial passages 44 formed in the pins 28. The radial passages 44 each intersect a longitudinal passage 46 in each of the pins 28. The longitudinal passage 46 is terminated by a pair of radial passages 48 and 50, which distribute fluid between the passage 46 and the bearings 32.

The sun gear member 16 is drivingly connected with a hub 15 and is rotatably supported on a shaft 52, which drivingly connects with a hub 54 that in turn is drivingly connected with the ring gear member 18. The shaft 52 is rotatably supported on a shaft 56. The shaft 56 has a central passage 58, which is communicated to the lubrication system of a planetary transmission in which the planetary arrangement 10 is a member. A plurality of radial passages 60 formed in the shaft 56 communicates between the passage 58 and a plurality of radial passages 62 formed in the shaft 52. The radial passages 62 are aligned with an inner portion 64 of the extension 36. Lubrication fluid which flows within the passage 58 is distributed through the passages 60 and 62 to the inner portion 64 of the extension 36 and therefore to the passages 38.

The planetary gearset 14 includes a sun gear member 66, a ring gear member 68, and a planet carrier assembly member 70. The planet carrier assembly member 70 includes a planet carrier member 72 having a pair of side plates 74 and 76 in which are positioned a plurality of support pins 78. Pinion gears 80 are rotatably mounted with bearings 82 on the pins 78. The sun gear member 66 has an extension 84, which rotates in unison therewith. The extension 84 has radial passages 86, which is aligned with radial passages 88 formed in the shaft 56 and communicate with the passage 58. The passages 86 are alignable with a plurality of passages 90 and an oil gallery 91 formed in the side plate 74, which in turn are aligned with passages 92 formed in the pins 78. Longitudinal passages 94 formed in the pins 78 are intersecting the passages 92 and communicating with radial passages 96 which are also formed in the pins 78. The radial passages 96 communicate with the bearings 82 to provide lubrication flow thereto.

The planet carrier side plate 76 is drivingly connected with a driven member 98 of a conventional synchronizer assembly 100. The synchronizer assembly 100 includes a control sleeve or collar 102, which has an inner spline 104 connectible with the driven member 98, an outer spline 106 connectible with a portion 108 of a transmission housing and an inner spline 110 drivingly connected with a hub 112, which is connected with the side plate 26 of the planet carrier member 22.

In the position of the synchronizer assembly 100, that is seen in FIG. 1, the planet carrier member 72 and planet carrier member 22 are held stationary through the synchronizer 100 and the transmission housing portion 108. Under this condition, the sun gear members 16 and 66 are both rotated either by the hub 51 or the shaft 52 or both. The hub 51 and shaft 52 are equally connectible with a transmission input member, not shown.

During transmission operation, either the planet carrier members 22 and 72 are rotated or held stationary. However, during transmission operation, the sun gear members 16 and 66 continue to rotate. Rotation of the sun gear member 16 will induce centrifugal oil flow or lubrication from the passage 58 to the passages 40 and 44, which in turn distribute fluid through passages 46, 48 and 50 through the space between bearings 32 thereby providing lubrication fluid to the pinion gears 30 even though the planet carrier member 22 is held stationary by the synchronizer 100 and the housing portion 108.

The sun gear member 66, as previously mentioned, is also continuously rotating during transmission operation such that the passages 86 and the extension 84 induce fluid lubrication flow from the passages 88 through the passages 90 and 92 to the passages 94. The passages 94 distributes fluid through the passages 96 to a space between the bearings 82 thereby providing lubrication flow for the rotating pinions even though the planet carrier member 72 is stationary.

During other periods of transmission operation, the planet carrier members 72 or 22 or both might be rotating, in which case the pressure fluid lubrication supplied at the inner surfaces of the extensions 36 and 84 will be induced to flow radially outward into the pinion gears by the centrifugal effect of the respective planet carrier members 22 and 72. Thus, during all phases of planetary operation that involve pinion to carrier relative motion, the pinion gears 30 and 80 will be receiving lubrication at their respective support bearings 32 and 82.

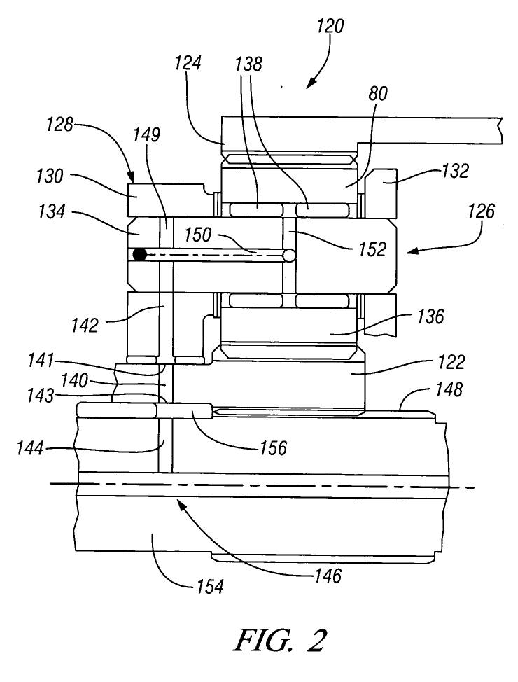

FIG. 2 describes a planetary gearset 120 having a sun gear member 122, a ring gear member 124, and a planet carrier assembly member 126. The planet carrier assembly member 126 includes a planet carrier member 128 having a pair of side plates 130 and 132 in which are interconnected by support pins 134. The support pins 134 rotatably support pinion gears 136 on a pair of bearings 138. The pinion gears 136 are disposed in meshing relationship with the sun gear member 122 and the ring gear member 124 and therefore rotate when either of these members rotates.

The sun gear member 122 has formed therein a plurality of radial passages 140 and annular oil galleries 141 and 143, which are alignable with a plurality of radial passages 142 formed in the side plate 130. The passages 140 are alignable with radial passages 144 formed in a drive shaft 146, which is drivingly connected through a spline 148 with the sun gear member 122. The passages 142 align with passages 149 formed in the pins 134 and each intersect a passage 150 formed longitudinally in the pins 134. Passage 150 communicates with a passage 152, which in turn communicates through a space between the bearings 138.

During operation of the planetary gearset 120, either the sun gear member 122 is rotatable or the planet carrier member 128 is rotatable. For example, if the sun gear member 122 is held stationary and the planet carrier member 128 is rotated either by an input drive or by rotation of the ring gear member 124, the planet carrier member 128 will be rotating relative to the shaft 146 which has a central passage 154 which supplies lubrication fluid to the transmission system in which the planetary gearset 120 is a member.

If the sun gear member 122 is held stationary and the planet carrier member 128 is rotated, the ring gear member 124 will rotate at an overdrive ratio, as is well known. If the ring gear member 124 is rotated and the sun gear member 122 is held stationary, the planet carrier member 128 will rotate at an underdrive ratio. During some planetary operations, the planet carrier member 128 is held stationary, however, the sun gear member 122 or the ring gear member 124 may be driven and the other members (sun/ring and pinions) will also be rotated due to this driving condition.

During this operation, lubrication fluid is supplied through the passages 144 to an area or volume 156 formed between the shaft 146 and the sun gear member 122. This lubrication fluid is impelled outwardly through the passages 140 and 142 by the centrifugal action of either the sun gear member 122 or the planet carrier side plate 130. The lubrication fluid impelled outwardly will be directed through the passage 150 to the passages 152, thereby providing lubrication for the bearings 138 which rotatably support the pinion gears 136. Therefore, when either the sun gear member 122 is being rotated, or the planet carrier member 128 is being rotated, or both are being rotated, lubrication fluid is distributed to the pinion gears 136 of the planet carrier assembly member 126.

1. A lubrication apparatus for a planetary gearset comprising:
a sun gear member and a planet carrier assembly member;
a lubrication fluid source adjacent an inner surface of said sun gear member and a radial passage communicating with said lubrication fluid source for outwardly directing lubrication fluid;
said planet carrier assembly member having planet carrier member with a side plate means for rotatably supporting pinion gear members disposed in meshing relationship with said sun gear member,
said side plate means including a radial passage alignable with said radial passage and said sun gear member for distributing fluid from said lubrication source and a pin members rotatably supporting said pinion gears; and
said pin members including a plurality of passage means formed therein for directing said lubrication fluid to an inner surface of said pinion gear members.

2. The lubrication apparatus for a planetary gearset defined in claim 1 further comprising:
at least one of said sun gear member and said planet carrier member being rotated during operation of said planetary gearset to enforce lubrication flow through centrifugal action.

3. A lubrication apparatus for a planetary gearset comprising:
a sun gear member and a planet carrier member including lubrication passage means;
a lubrication fluid source adjacent an inner surface of said sun gear member;
centrifugal means rotatable with said sun gear member for supplying lubrication fluid from said source to said planet carrier member lubrication passage means when said planet carrier member is stationary and said sun gear member is being rotated.

4. The lubrication apparatus for a planetary gearset defined in claim 3 further comprising:
said centrifugal means including radial passage means communicating between said lubrication fluid source and said planet carrier member lubrication passage means.
